(19) United States
(12) Patent Application Publication
(10) Pub. No.: US 2015/0352771 A1
(43) Pub. Date: Dec. 10, 2015

(54) BLOW-MOLDED PANEL ARTICLE, A MOLD AND A METHOD FOR ITS MANUFACTURE

(71) Applicant: KETER PLASTIC LTD., Herzlyia (IL)

(72) Inventor: Menachem TZOR, Carmiel (IL)

(21) Appl. No.: 14/760,931

(22) PCT Filed: Jan. 7, 2014
(86) PCT No.: PCT/IL2014/050021

§ 371 Date: Jul. 14, 2015

Related U.S. Application Data
(60) Provisional application No. 61/751,973, filed on Jan. 14, 2013.

(51) Int. Cl. B29C 49/00; B29C 49/42; B29C 49/28

(52) U.S. Cl. CPC B29C 49/0031; B29C 49/28; B29C 49/4273; B29L 2022/007

(57) ABSTRACT

A blow-molded rigid panel-like article comprising a top shell (60) having an outside surface and an inside surface, a bottom shell (68) having an outside surface and an inside surface, said top shell and bottom shell being uniformly spaced apart from bottom one another, defining a confined space (76) therebetween. The disclosure is also concerned with a mold and a method for manufacturing such a blow-molded rigid panel-like article.

### TECHNOLOGICAL FIELD

The presently disclosed subject matter is concerned with blow-molded articles, a mold and a method for manufacture of such articles. In particular the disclosure is concerned with the manufacturing of panels, i.e. artificial boards of material.

### BACKGROUND

Panels are commonly used in different industries such as automotive, furniture, partitioning systems and the like. Common requirements of such panels are their strength, rigidity and durability, i.e. resistance to sagging, warping and creeping under high stress loads, on the one hand, and light-weight along with relatively cheap and easy manufacturing of same.

### GENERAL DESCRIPTION

According to a first of its aspects the disclosed subject matter is concerned with a blow-molded panel-like article (hollow board of material).

According to a second aspect the disclosed subject matter there is disclosed a method for manufacturing of a blow-molded panel-like article.

According to yet an aspect of the disclosed subject matter there is disclosed a mold configured for manufacturing a blow-molded panel-like article according to the described method.

The term ‘panel’ as used hereinafter in the specification and claims denotes a substantially flat and thin, blow-molded board-article, comprising a space extending between two substantially parallely disposed shells.

According to a first embodiment of the first aspect, the disclosure is concerned with a blow-molded rigid panel-like article comprising a top shell having an outside surface and an inside surface, a bottom shell having an outside surface and an inside surface, said top shell and bottom shell being uniformly spaced apart from one another, defining a confined space therebetween.

According to a second embodiment the confined space is configured with a plurality of hollow tubular supports extending from the bottom shell towards the top shell, wherein a bottom end of the tubular supports is open at the outside surface of the bottom shell, and a top end of the tubular supports coextends with a the inside surface of the top shell.

In this configuration the top surface of the tubular supports coextend and are integrated with the bottom face of the top shell.

According to another aspect of the disclosure there is provided a mold for manufacturing a blow-molded panel-like article, the mold comprising a first plate and a second plate defining between them an initial molding gap; at least one of said first plate and said second plate being displaceable with respect to the other one, so as to increase the molding gap into a final molding space; the mold further configured with at least one inlet port for ingress of molten material into the molding gap and at least one gas inlet port for ingress of gas into the final molding space; a plurality of support studs extractable from one or both of said first plate and said second plate towards an inside surface of the other one or both of said first plate and said second plate; said support studs extending in spaced proximity with respect to said inside surface.

The term ‘final molding space’ as used hereinafter in the specification corresponds substantially to the final shape and dimensions of the blow-molded panel-like article.

According to some particular configurations of the mold according to the present disclosure can feature any one or more of the following designs and configurations, separately or in combination:
The first plate is displaceable with respect to the second plate;
The at least inlet port for ingress of molten material into the molding gap is configured at the second plate;
The at least one gas inlet port for ingress of gas into the final molding space is configured at the second plate;
The support studs project towards the inside surface of the first plate;
The support studs are articulated with a sealing frame associated with the first frame and movable therewith, whereby the distance between a free end of the support studs and the inside surface of the first plate remains substantially constant;
The sealing frame is configured for retaining a sealed parting line;
The distance between a free end of the support studs and the inside surface of the first plate is approximately 1-3 mm;
The initial molding gap is approximately between 1-10 mm thick;
Different materials or material with different properties, can be injected through the at least inlet port, to obtain a multi-component injection.

The present disclosure is also concerned with an article, such as a furniture article, configured with a panel-like article according to the disclosure.

According to yet another aspect of the present disclosure there is provided a method for manufacturing a blow-molded panel-like article, the method comprising the following steps:
i. obtaining a mold for manufacturing a blow-molded panel-like article, the mold comprising a first plate and a second plate defining between them an initial molding gap; at least one of said first plate and said second plate being displaceable with respect to the other one, so as to increase the molding gap into a final molding space; the mold further configured with at least one inlet port for ingress of molten material into the molding gap and at least one gas inlet port for ingress of gas into the final molding space;
ii. introducing molten plastic resin into the molding gap through the at least one inlet port to mold a solid layer;
iii. displacing one or both of the first plate and the second plate, so as to increase the molding gap into a final molding space;
iv. introducing a compressed gas through the at least one gas inlet port so as to blow the solid layer into two spaced apart shells, defining a confined space therebetween; and
v. opening the mold to extract the panel-like article.

According to another embodiment, the mold is further configured with a plurality of support studs extractable from one or both of said first plate and said second plate towards an inside surface of the other one or both of said first plate and said second plate; said support studs extending in spaced proximity with said inside surface; wherein step iii) above is performed whilst retaining the support studs at a substantially fixed distance from the inside surface, so that the confined space is created with a plurality of tubular supports extending therebetween.

Any one or more of the following, features, designs and configurations can be applied in a panel according to the present disclosure, or a method for its manufacturing, separately or in combinations thereof:
The panel can be molded with or without the tubular supports
A longitudinal axis of the tubular supports extends substantially normal to a plane of the panel;
The top shell and bottom shell are substantially of uniform thickness;
The thickness of the top shell is substantially similar to the thickness of the bottom shell;
The panel can be a planner article or assume a curved pattern, and can have any required shape;
Either or both of the top shell and the bottom shell of the panel can be transparent, translucent or opaque, and likewise can be colored;
Either surface of each of the top shell and the bottom shell can be patterned/texturized or smooth, said pattern imparted to the respective surface by texturizing of the mold or by flow of molten molding material;
The panel is molded of a plastic resin, setting as examples PP (Polypropylene), LDPE (Low-density polyethylene), HDPE (High-density polyethylene), ABS (Acrylonitrile butadiene styrene), TPE (Thermoplastic elastomers), TPV (Thermo-Plastic Vulcanizates; TPU (Thermoplastic polyurethane), PC (Polycarbonate), PMMA (Polymethyl methacrylate);
The thickness of the top shell and the bottom shell is between about 1 to 4 mm;
The top shell and the bottom shell are spaced apart about 3 to 15 times the thickness of a shell, and typically between about 4 to 10 times the thickness of a shell;
The thickness of the tubular supports wall is about the same thickness of the thickness of the shells, or more;
The tubular supports can be substantially equally distributed within the space of the panel;
The tubular supports between the spaced shells can have a cylindrical cross-section, an elliptic cross-section or a polygonal cross-section;
An extracting mechanism is configured for retracting the panel-like article from the mold. The extracting mechanism can be in the form of one or more extracting members displaceable between a retracted molding position at which they substantially do not project into the molding space, and an extracting position wherein said one or more extracting members project into the molding space so as to extract the panel-like article and detach it from the mold;
The one or more extracting members can be in the form of sleeves axially displaceable about the support pins.

### BRIEF DESCRIPTION OF THE DRAWINGS

In order to understand the disclosure and to see how it may be carried out in practice, embodiments will now be described, by way of a non-limiting examples only, with reference to the accompanying drawings, in which:

FIG. 1A is a section through a mold at a first step of injecting a panel-like article according to the present disclosed subject matter;

FIG. 1B is an enlargement of the portion marked I in FIG. 1A;

FIG. 2A is a section through the mold of FIG. 1, at a second step of injecting the panel-like article;

FIG. 2B is an enlargement of the portion marked II in FIG. 2A;

FIG. 3A is an enlarged portion of the molding space at the first molding step, after molding a solid layer into the initial molding gap;

FIG. 3B is an enlarged portion of the molding space at the second molding step, after blowing the solid layer at the final molding space;

FIG. 4A is an isometric top view of a panel-like article according to the present disclosed;

FIG. 4B is an isometric bottom view of the article of FIG. 4A;

FIG. 5A is an enlarged section taken along lines A-A in FIG. 4B;

FIG. 5B is an enlarged section taken along lines B-B in FIG. 4A;

FIG. 6 is a perspective view of an inside surface of a bottom shell, according to an embodiment of the disclosure;

FIGS. 7A to 7C are a section through a mold according to a different configuration, illustrating different positions of the mold during an injection process for molding a panel-like article according to the present disclosed subject matter;

FIG. 8 is a section of a bottom plate of a mold according to a modification of the disclosure, configured with an article extracting mechanism;

FIG. 9A is a section through a mold at a first step of injecting a panel-like article according to another example of the present disclosed subject matter, wherein the molded panel is devoid of support studs;

FIG. 9B is a section through the mold of FIG. 9A, at a second step of injecting the panel-like article; and

FIG. 10 is a sectioned portion of a panel-like article without any tubular supports.

### DETAILED DESCRIPTION OF EMBODIMENTS

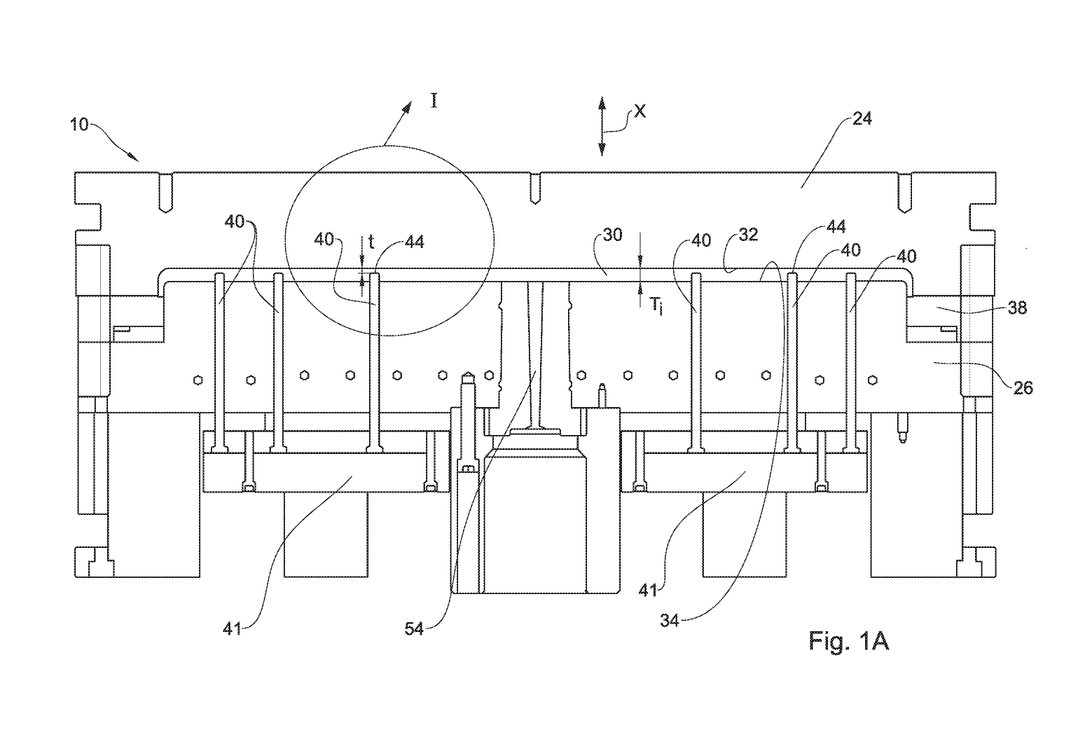

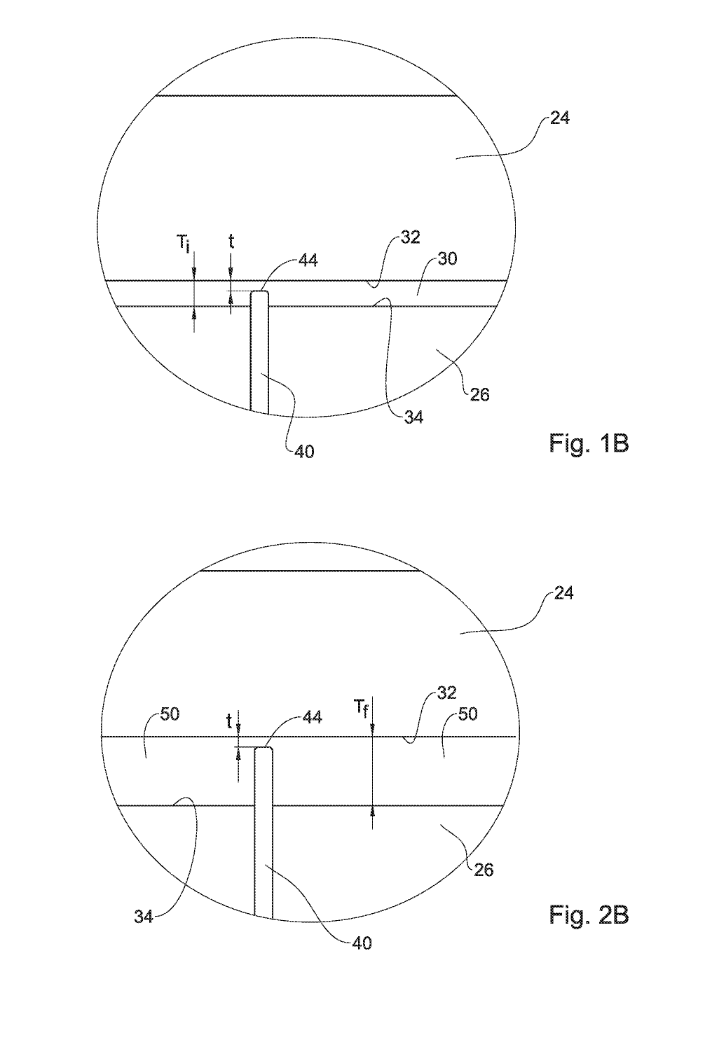

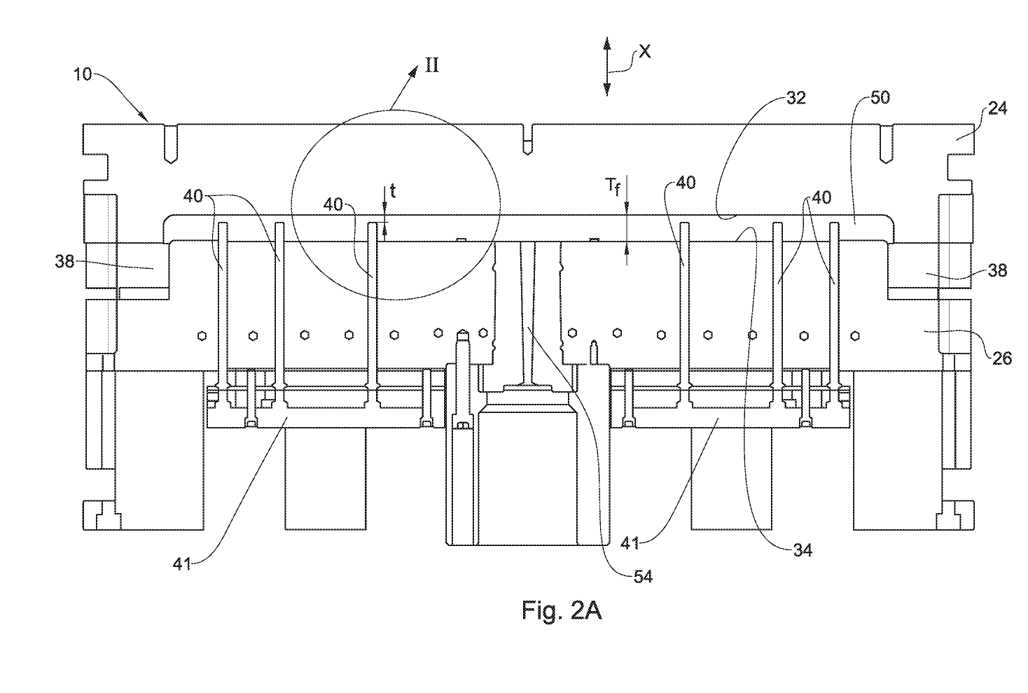

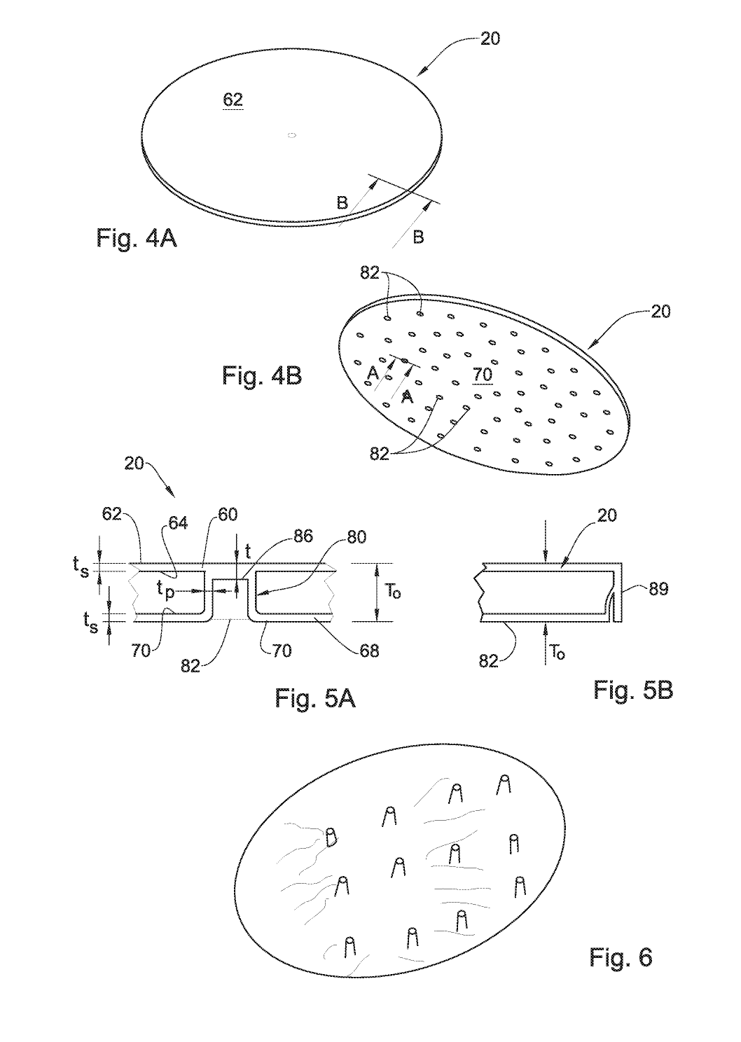

Attention is first directed to FIGS. 1 to 2 of the drawings illustrating a section of a mold generally designated 10, useful in the manufacturing process of a blow-molded panel-like article, e.g. table top 20 illustrated by way of example, and discussed in further detail with reference to FIGS. 4 and 5.

The mold 10 comprises a first plate 24 and a second plate 26 defining between them an initial molding gap 30 having a thickness designated Tᵢ. The initial molding gap 30 is a space extending between a bottom surface 32 of the first plate 24, and a top surface 34 of the second plate 26 (FIGS. 1A and 2A). In the illustrated example the first plate 24 is configured for axial displacement with respect to the second plate 26, along longitudinal axis X, so as to increase the molding gap into a final molding space having a thickness designated T_{f} (FIGS. 1B and 2B).

It is however appreciated that according to other configurations (not illustrated) any one or both of the first plate and the second plate can be displaceable so as to increase the molding space therebetween.

The initial molding gap 30 is bounded by a sealing frame 38 configured for displacing with the first plate 24 and for sealing a parting line between the first plate 24 and the second plate 26. A plurality of support studs 40 are set on carriers 41 articulated with the sealing frame 38, said support studs 40 extending through the second plate 26 and projecting from the top surface 34, and being axially displaceable within said second plate 26, by virtue of displacement of the sealing frame 38.

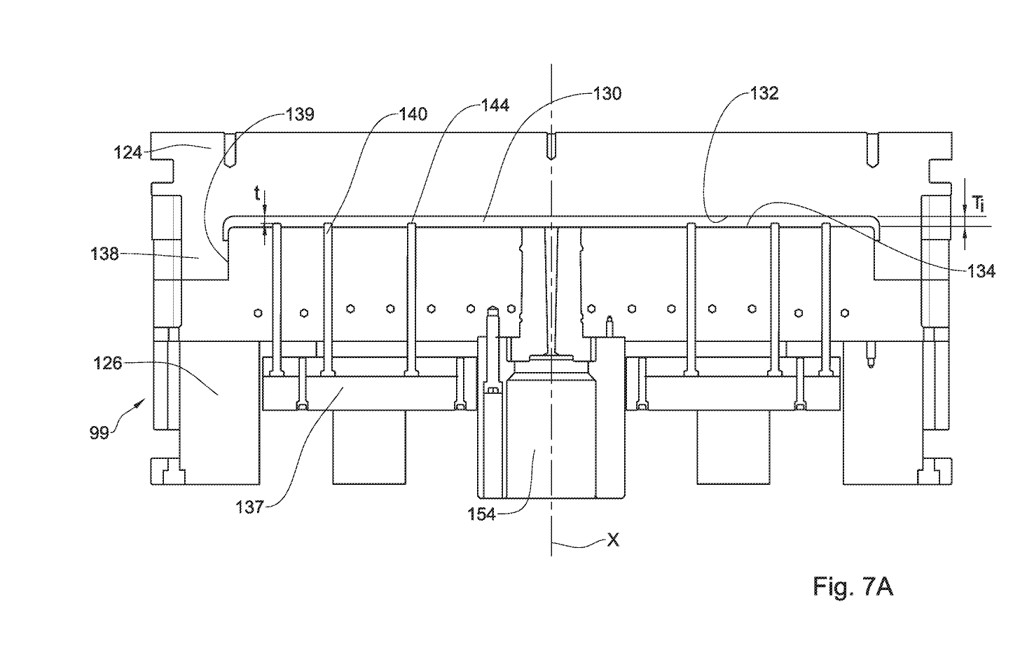

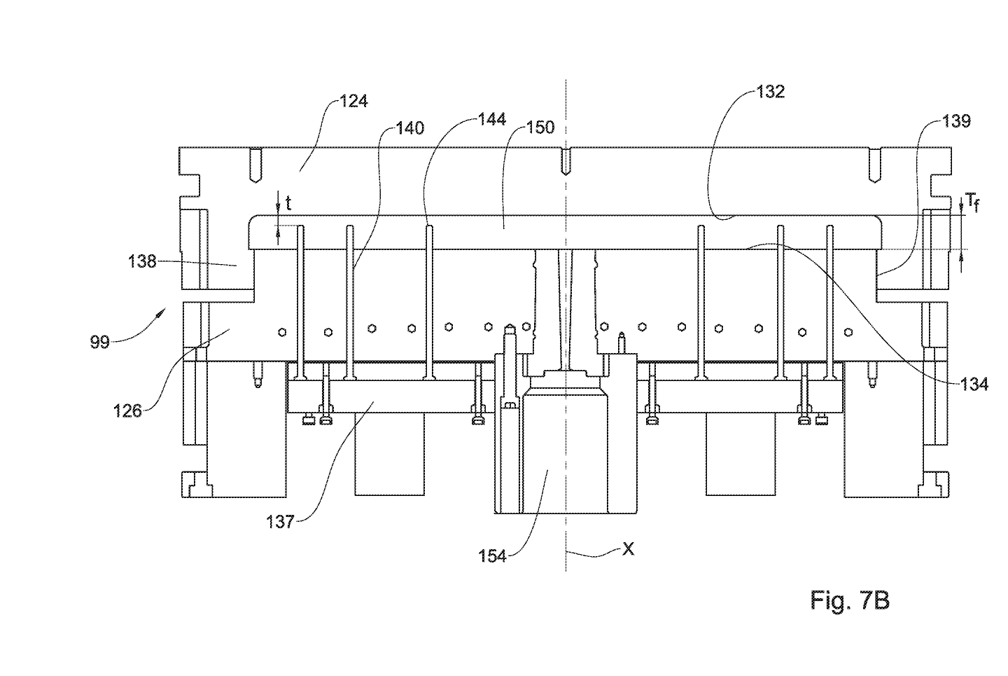

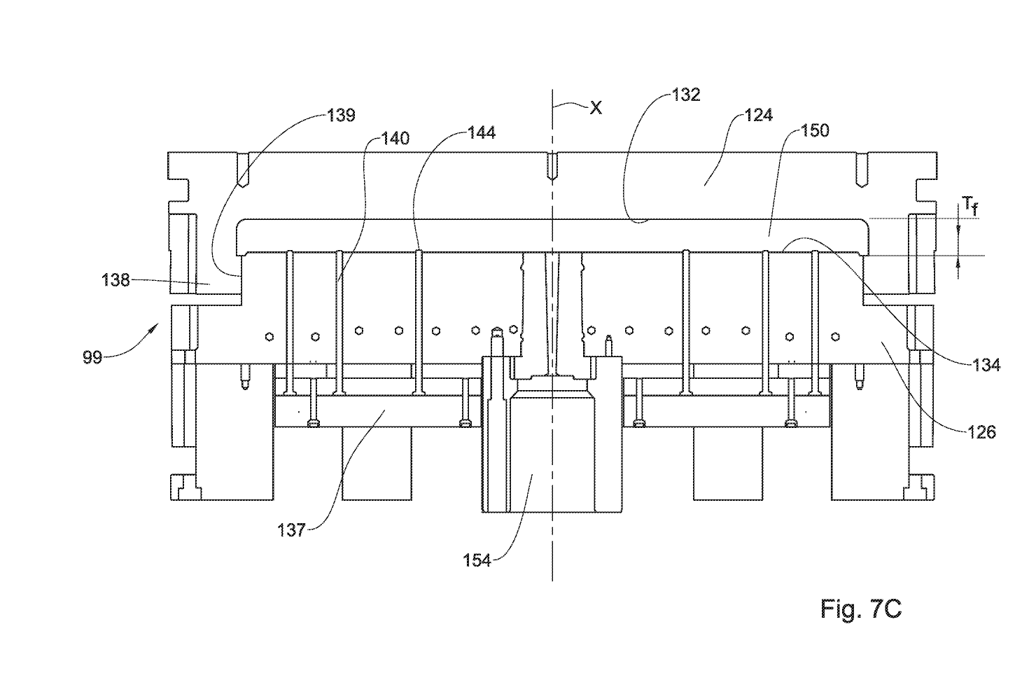

In the illustrated example, sealing frame 38 is independent from the first plate 24, yet configured for displacement in register (or independent therefrom, however retaining a sealed molding gap with displacement of the one or both mold frame members, so as to ensure sealing of the molding gap also as it expands (as will be discussed hereinafter in further detail). However, it is appreciated that according to other configurations, and as will be illustrated hereinafter with reference to FIGS. 7A to 7C, the sealing frame can be articulated to or integrated with the first frame (or the bottom frame, however not illustrated), to ensure in-register displacement of the sealing plate 38 with respect to the first plate 24.

As can be seen in the drawings, also in FIGS. 1B and 2B, the top, free end 44 of the support studs extends at a distance t from the bottom surface 32 of the first plate 24, that being the case for both the initial stage with the initial molding gap 30 extending between the first plate 24 and the second plate 26 (FIGS. 1A and 2A), and at the final molding stage where a final molding space 50 having a thickness designated T_{f} (FIGS. 1B and 2B). Thus, free end 44 of the support studs 40 extends at a fixed distance t from the bottom surface 32 of the first plate 24.

Though not illustrated, it is appreciated that the plurality of support studs can extend from either one or both of said first plate and said second plate towards the inside surface of the other one or both of said first plate and said second plate, however wherein said support studs extend in spaced proximity t from said inside surface.

As can further be seen the second plate 26 is further configured with an inlet port 54 for ingress of molten material into the initial molding gap 30, and for ingress of gas into the final molding space 50 (FIGS. 2A and 2B). Whilst in the present example molten resin (plastic material) and gas are introduced through the same inlet port 54 extending through the second plate 26, it is appreciated that either or both of the first plate 24 and the second plate 26 can be configured with one or more openings for introducing molten material and gas into the molding space, and further wherein the molten material and the gas can be introduced through the same one or more openings.

Not illustrated, but as can further be appreciated by a man of the art, the mold 10 is configured for assembly in a molding machine comprising a displacing mechanism for displacing the mold plates, a hopper for raw plastic granules, a melting unit, an array of fluid ducts for conveying molten resin and gas flow to the inlet port/s, as well as a control unit, etc.

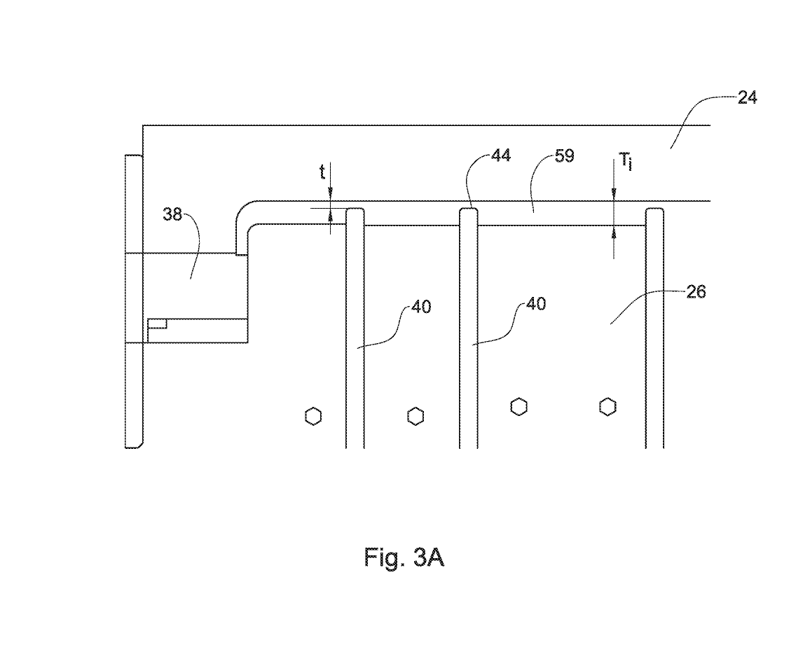

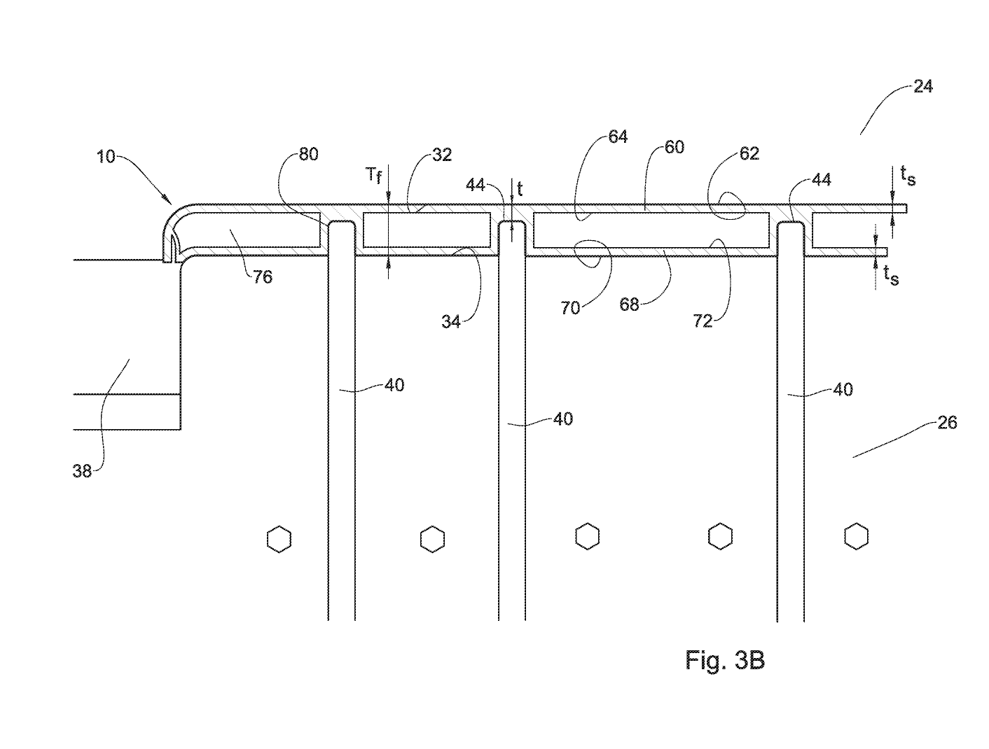

With further attention also to FIGS. 3A and 3B, there will now be discussed a molding process for the manufacturing of a blow-molded panel-like article, e.g. table top 20 (FIGS. 4 and 5), using a mold 10 of the above type, with the following steps:
i. The mold is set at its initial molding position (i.e. FIGS. 1A and 1B), wherein the molding space is at the so-called initial molding gap 30 position, having a thickness Tᵢ;
ii. A molten resin (e.g. plastic material) is introduced through the inlet port 54 into the initial molding gap 30, allowing it to occupy the entire molding space 30 extending between the bottom surface 32 of the first plate 24 and the top surface 34 of the second plate 26. The molded material at this step is referred to a ‘solid layer’ and is designated 59 (FIG. 3A);
iii. Before solidifying of the molten material (the solid layer 59) within the initial molding gap 30, the mold is transitioned into its second molding step, i.e. expanding the molding space into a final molding space 50 having a thickness designated T_{f} (FIGS. 2A and 2B). This is carried out by axially displacing the first plate 24 and the articulated sealing frame 38 in direction away from the second plate, however while retaining the molding space substantially sealed, and further with corresponding displacement of the carriers 41 and the articulated support studs 40, such that their free ends 44 extend at said fixed distance t from the bottom surface 32 of the first plate 24;
iv. A gas is pressurized into the final molding space 50 through a gas inlet port, which in the illustrated example is the same inlet port designated 54. The gas pressurized into the molten material within the expanded molding space (the final molding space 50 having a thickness T_{f}) results in blowing of the molten material (the solid layer), giving rise to a pouch-like configuration (FIG. 3B), comprising a top shell 60 having an outside surface 62 and an inside surface 64, a bottom shell 68 having an outside surface 70 and an inside surface 72, said top shell 60 and bottom shell 68 being substantially uniformly spaced apart from one another, defining a confined hollow space 76 therebetween. The flow of the molten material within the molding space and around the support studs 40 (having their free ends 44 spaced at a distance t from the bottom surface 32 of the first mold 24) results in formation of a plurality of hollow tubular supports 80 (seen also in FIG. 5A) extending from the bottom shell 68 towards the top shell 60.

v. Retracting the support studs 40 and removing the molded article 20 reveals a panel-like article (FIG. 5A), wherein a bottom end 82 of the tubular supports 80 is open at the outside (bottom) surface 70 of the bottom shell 68, and a top end 86 of the tubular supports 80 coextends with the inside surface 64 of the top shell 60.

According to a particular example, the following ratios were obtained when molding a panel-like article:

The thickness tₛ of the top shell 60 and of the bottom shell 68 is substantially identical;

The thickness tₛ of the top shell 60 and of the bottom shell 68 is about half the thickness of the solid layer 59 (substantially corresponding with Tᵢ);

The overall thickness Tₒ of the molded panel-like article 20 (FIG. 5A) is about 7 times the thickness of the solid layer 59, i.e. about 4-10 times thickness Tᵢ. In turn, the over all thickness Tₒ of the molded panel-like article 20 substantially corresponds with the final molding space 50 having a thickness designated T_{f};

The thickness tₚ of the hollow tubular supports 80 (FIG. 5A) is substantially the same as the thickness tₛ of the top shell 60 and of the bottom shell 68.

In this configuration the top surface of the tubular supports coextends and is integrated with the bottom face 64 of the top shell 62.

Side edges 89 of molded panel-like article 20 (FIG. 5B) can be overlaid and comprise two layers of material, and likewise can be staggered or be otherwise designed.

It is appreciated that the panel-like article can be a flat planner article or it can assume a curved pattern (not shown) and further can have any required shape. Furthermore, either or both of the top shell 60 and the bottom shell 68 of the panel 20 can be transparent, translucent or opaque, and likewise can be colored. Either or both the inside and the outside surface of any of the top shell 60 and the bottom shell 68 can be patterned/texturized or smooth, said pattern imparted to the respective surface by texturizing of the mold or by flow of molten molding material.

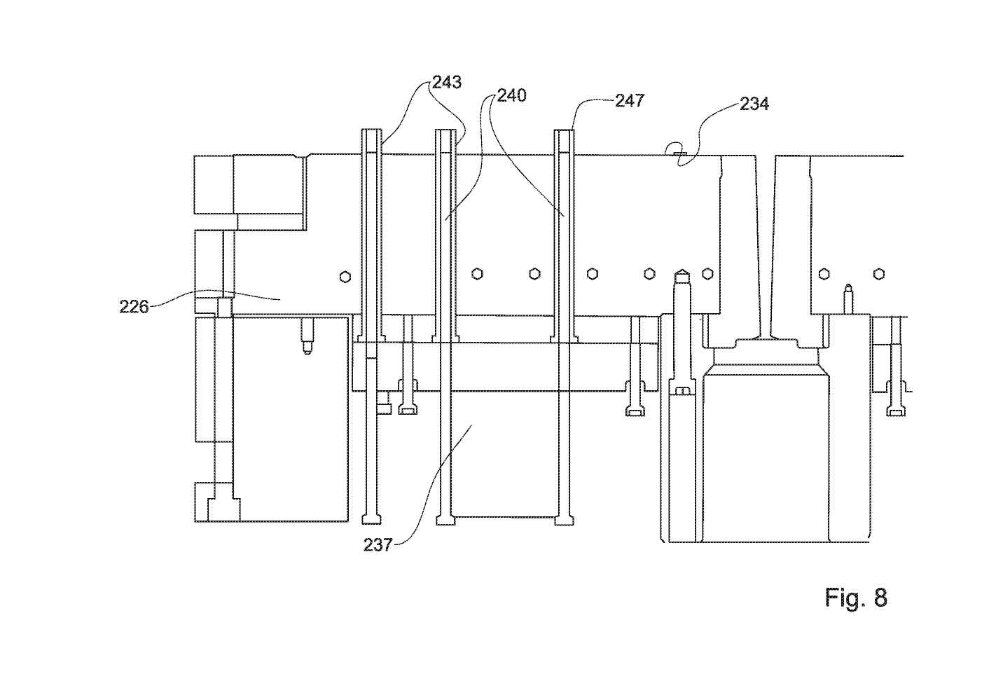

Turning now to FIGS. 7 and 8 there are illustrated alternative mold configurations suitable for molding a panel-like article in accordance with the present disclosed subject matter.

With specific reference being made now to FIGS. 7A to 7C there is illustrated a mold according to a modification of the disclosure, generally designated 99, suited for use in the process for manufacturing a panel-like article in accordance with the present disclosed subject matter. Elements similar to those disclosed in connection with FIGS. 1 to 3 are designated with like reference numbers, however shifted by 100.

The mold 99 comprises a first plate 124 and a second plate 126 defining between them an initial molding gap 130 (FIG. 7A) having a thickness designated Tᵢ. The initial molding gap 130 is a space extending between a bottom surface 132 of the first plate 24, and a top surface 134 of the second plate 126. In the illustrated example the first plate 124 is configured for axial displacement with respect to the second plate 126, along longitudinal axis X, so as to increase the molding gap into a final molding space having a thickness designated T_{f} (FIGS. 7B and 7C). It is however appreciated that according to other configurations (not illustrated) any one or both of the first plate and the second plate can be displaceable so as to increase the molding space therebetween.

The initial molding gap 130 is bounded by a sealing frame 138 which is integral with the first plate 124 and configured for sealing the molding gap 130 between the first plate 124 and the second plate 126. Thus it is seen that the sealing frame 138 is displaceable about vertical side walls 139 of the second frame 126 in a sealed fashion.

A pin carrying plate 137 extends below the second plate 126 and is fitted with a plurality of support studs 140, said support studs 140 extending through the second plate 126 and projecting from the top surface 134, and being axially displaceable within said second plate 134, by virtue of displacement of the pin carrying plate 137, the later configured for corresponding displacement together with the first plate 124.

Similar to the arrangement disclosed in the previous example, and as can be seen in the drawings, also in FIGS. 1B and 2B, the top, free end 144 of the support studs 140 extends at a distance t from the bottom surface 132 of the first plate 124, that being the case for both the initial stage (FIG. 7A) with the initial molding gap 130 extending between the first plate 124 and the second plate 126 (FIGS. 7A and 2A), and at the final molding stage (FIG. 7B) where a final molding space 150 having a thickness designated T_{f} (FIGS. 7C and 2B).

As can further be seen the second plate 126 is further configured with an inlet port 154 for ingress of molten material into the initial molding gap 130, and for ingress of gas into the final molding space 150 (FIG. 7C). Whilst in the present example molten resin (plastic material) and gas are introduced through the same inlet port 154 extending through the second plate 126, it is appreciated that either or both of the first plate 124 and the second plate 126 can be configured with one or more openings for introducing molten material and gas into the molding space, and further wherein the molten material and the gas can be introduced through the same one or more openings.

Operation of a molding process using mold 99 is similar to that disclosed in connection with the previous example.

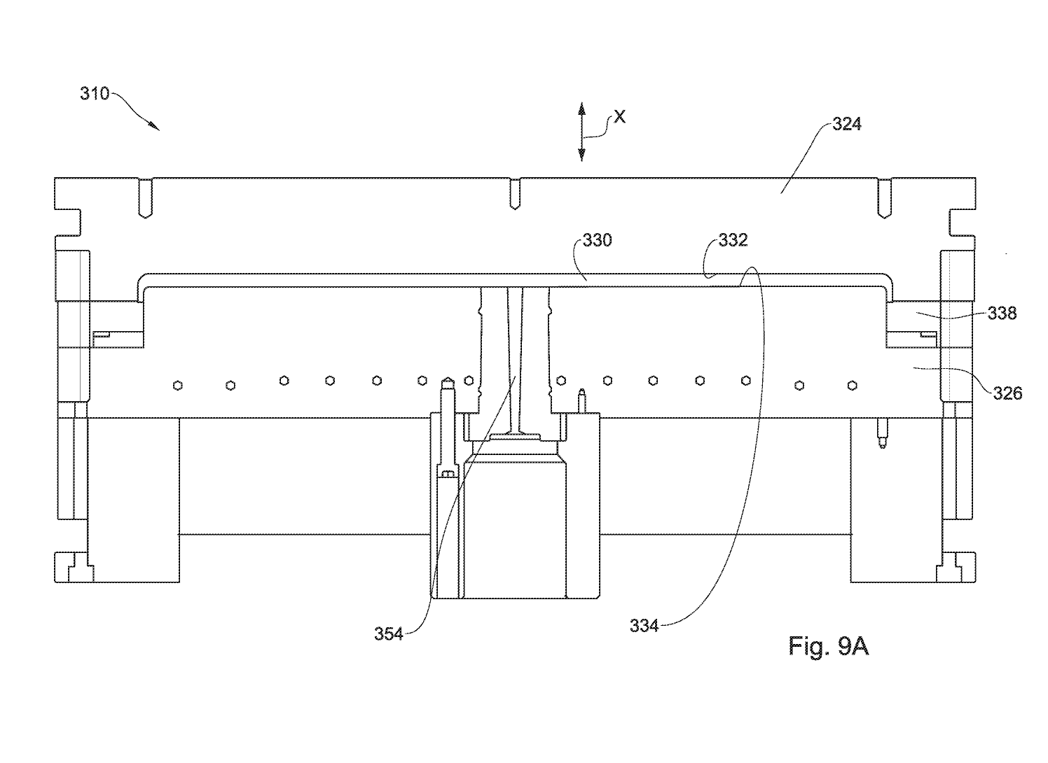

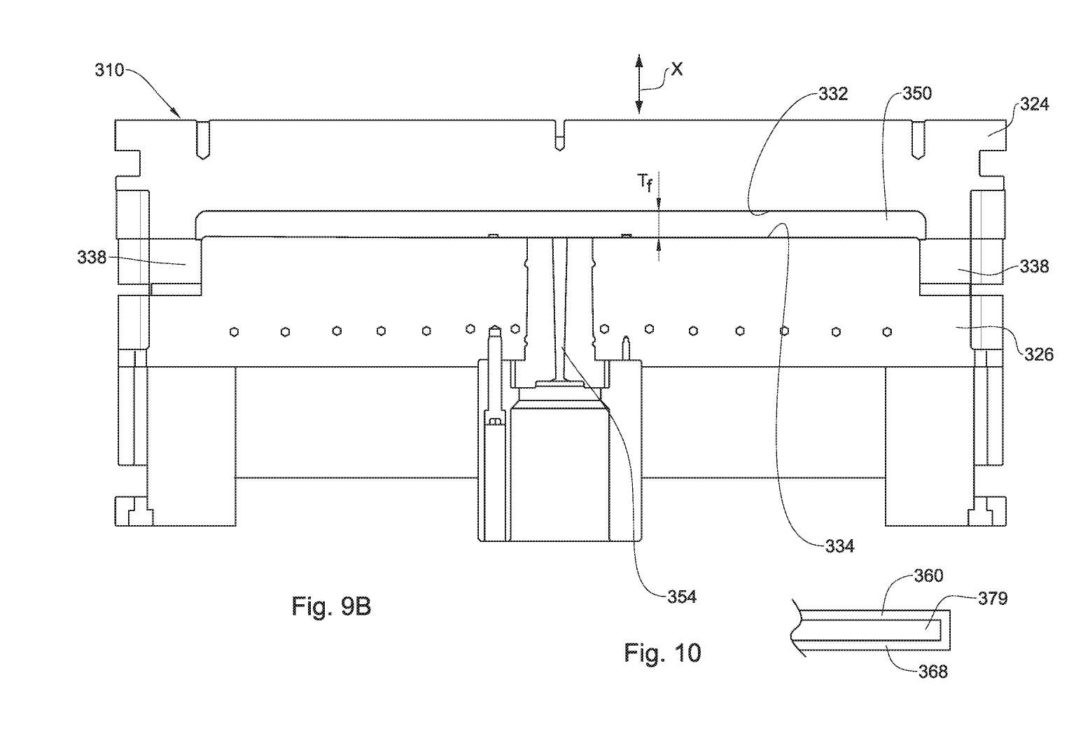

According to a different embodiment of the disclosure, a panel-like article according to the disclosure can be molded similar to the previously discussed example, however without the support studs, wherein rigidity of the top shell and the bottom shell is sufficient to prevent buckling and deformation of the board. For that purpose a mold system is used, similar to that disclosed hereinbefore, however devoid of the support studs or where the support studs are do not participate during the molding process. Attention is directed to FIGS. 9A and 9B illustrating such a mold system, generally designated 310, wherein like components as in the previous example are designated like reference numbers, shifted by 300.

It is noted that the mold system 310 is similar to the mold system 10 and whereby a molding process takes place similarly as in the method disclosed hereinabove, however without the support studs act of forming the tubular supports, mutatis mutandis. As can thus be appreciated, and noted in FIG. 10, the panel-like article manufactured by using such a mold and according to this method, has a hollow space 379 extending between the top shell 360 and the bottom shell 368 is substantially free of any supports.

Turning now to FIG. 8 of the drawings there is illustrated an example of an extracting mechanism for extracting the panel-like article from the mold. Elements similar to those disclosed in connection with FIGS. 1 to 3 are designated with like reference numbers, however shifted by 200.

For extracting the panel-like article from the mold, the pin carrying plate 237 of the second mold 226 is configured with a plurality of support pins 240, each being coaxially displaceable within a corresponding extracting sleeve 243, wherein the support pins 240 are configured for displacement with respect to the first plate (not shown) in a fashion so as to maintain a substantially fixed gap from a bottom surface of the first plate, as discussed hereinabove, whilst the extracting sleeve 243 slidingly displace axially over the support pins 240 only when it is required to extract and remove the molded panel-like article (not shown). It is noted that during the molding process, the extracting sleeve 243 are retained at their retracted position such that their top end 247 does not project from the top surface 234 of the second plate 226, and is substantially flush therewith.

Accordingly, once the molding of the panel-like article is complete, the mold is opened by displacing either or both the first plate and the second plate, and then only the extracting sleeve 243 project from the top surface 234 of the second plate 226 to thereby bear against a bottom face of the panel-like article and extract it from the second plate. During the extracting stage, the support pins 240 can retract or remain at their top position.

1. A blow-molded rigid panel-like article comprising a top shell having an outside surface and an inside surface, a bottom shell having an outside surface and an inside surface, said top shell and bottom shell being uniformly spaced apart from one another, defining a confined space therebetween.

2. A blow molded panel-like article according to claim 1, wherein the confined space is configured with a plurality of hollow tubular supports extending from the bottom shell towards the top shell, wherein a bottom end of the tubular supports is open at the outside surface of the bottom shell, and a top end of the tubular supports coextends with a the inside surface of the top shell.

3. A blow molded panel-like article according to claim 2, wherein the top surface of the tubular supports coextend and are integrated with the bottom face of the top shell.

4. A blow-molded panel-like article according to claim 2, wherein a longitudinal axis of the tubular supports extends substantially normal to a plane of the panel-like article.

5. A blow-molded panel-like article according to claim 1 or 2, wherein the top shell and bottom shell are substantially of uniform thickness.

6. A blow-molded panel-like article according to claim 1 or 2, wherein the thickness of the top shell is substantially similar to the thickness of the bottom shell.

7. A blow-molded panel-like article according to claim 1 or 2, wherein the thickness of the top shell and the bottom shell is between about 1 to 4 mm.

8. A blow-molded panel-like article according to claim 1 or 2, wherein the top shell and the bottom shell are spaced apart about 3 to 15 times the thickness of a shell, and typically between about 4 to 10 times the thickness of a shell.

9. A blow-molded panel-like article according to claim 2, wherein the thickness of wall of the tubular supports is about the same thickness of the thickness of the shells, or more.

10. A blow-molded panel-like article according to claim 2, wherein the tubular supports are substantially equally distributed within the space of the panel-like article.

11. A blow-molded panel-like article according to claim 2, wherein the tubular supports between the spaced shells have a cylindrical cross-section, an elliptic cross-section or a polygonal cross-section.

12. A method for manufacturing a blow-molded panel-like article, the method comprising the following steps:
i. obtaining a mold for manufacturing a blow-molded panel-like article, the mold comprising a first plate and a second plate defining between them an initial molding gap; at least one of said first plate and said second plate being displaceable with respect to the other one, so as to increase the molding gap into a final molding space; the mold further configured with at least one inlet port for ingress of molten material into the molding gap and at least one gas inlet port for ingress of gas into the final molding space;
ii. introducing molten plastic resin into the molding gap through the at least one inlet port to mold a solid layer;
iii. displacing one or both of the first plate and the second plate, so as to increase the molding gap into a final molding space;
iv. introducing a compressed gas through the at least one gas inlet port so as to blow the solid layer into two spaced apart shells, defining a confined space therebetween; and
v. opening the mold to extract the panel-like article.

13. A method according to claim 12, wherein the mold is further configured with a plurality of support studs extractable from one or both of said first plate and said second plate towards an inside surface of the other one or both of said first plate and said second plate; said support studs extending in spaced proximity with said inside surface; wherein step iii) above is performed whilst retaining the support studs at a substantially fixed distance from the inside surface, so that the confined space is created with a plurality of tubular supports extending therebetween.

14. A method for manufacturing a blow-molded panel-like article according to claim 13, wherein a longitudinal axis of the support studs extends substantially normal to a plane of the panel-like article.

15. A method for manufacturing a blow-molded panel-like article according to claim 12, wherein a top shell and a bottom shell of the panel-like article are substantially of uniform thickness.

16. A method for manufacturing a blow-molded panel-like article according to claim 12, wherein the thickness of a top shell and a bottom shell of the blow-molded panel-like article is between about 1 to 4 mm.

17. A method for manufacturing a blow-molded panel-like article according to claim 12, wherein a top shell and a bottom shell are spaced apart about 3 to 15 times the thickness of a shell, and typically between about 4 to 10 times the thickness of a shell.

18. A method for manufacturing a blow-molded panel-like article according to claim 13, wherein tubular supports are molded over the support studs, said tubular supports being integrated with walls of the panel-like article.

19. A method for manufacturing a blow-molded panel-like article according to claim 18, wherein a wall of tubular supports is about the same thickness of the thickness of a top shell and a bottom shell of the panel-like article, or more.

20. A method for manufacturing a blow-molded panel-like article according to claim 13, wherein the support studs are substantially equally distributed within the space of the mold.

21. A method for manufacturing a blow-molded panel-like article according to claim 13, wherein the top surface of the tubular supports coextend and are integrated with the bottom face of the top shell.

22. A mold for manufacturing a blow-molded panel-like article, the mold comprising a first plate and a second plate defining between them an initial molding gap; at least one of said first plate and said second plate being displaceable with respect to the other one, so as to increase the molding gap into a final molding space; the mold further configured with at least one inlet port for ingress of molten material into the molding gap and at least one gas inlet port for ingress of gas into the final molding space.

23. A mold for manufacturing a blow-molded panel-like article according to claim 22, wherein the mold is further configured with a plurality of support studs extractable from one or both of said first plate and said second plate towards an inside surface of the other one or both of said first plate and said second plate; said support studs extending in spaced proximity with respect to said inside surface.

24. A mold for manufacturing a blow-molded panel-like article according to claim 22, wherein the first plate is displaceable with respect to the second plate.

25. A mold for manufacturing a blow-molded panel-like article according to claim 22, wherein the at least inlet port for ingress of molten material into the molding gap is configured at the second plate.

26. A mold for manufacturing a blow-molded panel-like article according to claim 22, wherein the at least one gas inlet port for ingress of gas into the final molding space is configured at the second plate.

27. A mold for manufacturing a blow-molded panel-like article according to claim 23, wherein the support studs project towards the inside surface of the first plate.

28. A mold for manufacturing a blow-molded panel-like article according to claim 23, wherein the support studs are articulated with a sealing frame associated with the first frame and movable therewith, whereby the distance between a free end of the support studs and the inside surface of the first plate remains substantially constant.

29. A mold for manufacturing a blow-molded panel-like article according to claim 22, wherein a sealing frame is configured for retaining a sealed parting line.

30. A mold for manufacturing a blow-molded panel-like article according to claim 23, wherein the distance between a free end of the support studs and the inside surface of the first plate is approximately 1 to 3 mm.

31. A mold for manufacturing a blow-molded panel-like article according to claim 22, wherein the initial molding gap is approximately between 1-10 mm thick.

32. A mold according to claim 22 or 23, further comprising an extracting mechanism for retracting the panel-like article from the mold, said extracting mechanism comprising one or more extracting members displaceable between a retracted molding position at which they substantially do not project into the molding space, and an extracting position wherein said one or more extracting members project into the molding space so as to extract the panel-like article and detach it from the mold.

33. A mold according to claim 32, wherein the one or more extracting members are in the form of sleeves axially displaceable about the support studs.
